(19) United States
(12) Patent Application Publication
(10) Pub. No.: US 2019/0049226 A1
(43) Pub. Date: Feb. 14, 2019

(54) DETONATOR INFORMATION SYSTEM

(71) Applicant: DETNET SOUTH AFRICA (PTY) LTD (ZA), Sandton (ZA)

(72) Inventors: Abraham Johannes Liebenberg, Kempton Park (ZA); Michiel Jacobus Kruger, Rembrandt Park (ZA); Aldaine Whyte, Pretoria East (ZA)

(21) Appl. No.: 15/570,957

(22) PCT Filed: May 4, 2016
(86) PCT No.: PCT/ZA2016/050014

§ 371 Date: Oct. 31, 2017

(30) Foreign Application Priority Data
May 12, 2015 (ZA) 2015/03271

(51) Int. Cl. F42D 1/055; F42D 3/06; G01W 1/06

(52) U.S. Cl. CPC F42D 1/055; F42D 5/00; G01W 1/06; F42D 3/06

(57) ABSTRACT

A blasting system in which environmental and installation data prevailing at the time a detonator is loaded into a borehole are stored in the detonator and are made available to an operator before the detonator is fired.

### BACKGROUND OF THE INVENTION

This invention relates generally to the use of one or more detonators in a geophysical exploration process to generate seismic information and more particularly is concerned with the provision of information, to an operator or to a control system, which relates to conditions at a borehole in which a detonator is located.

In a geophysical exploration process use can be made of one or more electronic detonators to initiate an explosive which creates seismic waves. Reflections of the seismic waves by geophysical formations and discontinuities in the earth are measured and are processed to obtain an indication of properties below the earth's surface.

In a seismic application boreholes are normally primed well in advance before firing the respective detonators in the boreholes. It is not uncommon for a period of several weeks to pass, once a detonator is loaded into a borehole, before the detonator is blasted. It is essential, therefore, at all times, to have continuity of information relating to the blast site for, otherwise, an unattended primed borehole with a seismic blasting detonator may inadvertently be initiated.

Generally adequate techniques are available in the prior art to prevent a detonator from being prematurely initiated by an extraneous signal. For example a detonator may be constructed so that it is responsive only to a specific encoded firing signal. There are however other factors which could potentially adversely influence a blasting process. These factors might be identified when a borehole is loaded with explosive and a detonator but, by the time the detonator is to be fired, such information may not be readily available or may not be properly presented to an operator.

An object of the present invention is to provide a blasting system wherein the aforementioned shortcoming is addressed at least to some extent.

### SUMMARY OF THE INVENTION

The invention provides a blasting system which is established at a blast site and which includes at least one detonator and explosive loaded into a borehole and wherein the detonator includes a memory in which is stored data selected from environmental and installation information prevailing at least at the time the detonator is loaded into the borehole and wherein such data is presented to an operator or to a component of the blasting system, e.g. a display before firing of the detonator takes place.

The information may be presented to the operator or to the component of the blasting system upon request. Alternatively or additionally the data may be automatically presented to the operator or to the component of the blasting system when a particular stage in a blasting process is reached.

The data which is stored may be based on information selected from one or more of the following aspects:
(1) Environmental information e.g. temperature and humidity levels, at a blast site.
(2) Cautions—depth of borehole, presence of water in the borehole, or any other information to caution an operator before firing of the detonator in the borehole is to take place.
(3) An identity number assigned to the borehole or to the detonator.
(4) GPS coordinates—an actual GPS position of the borehole measured when the detonator in the borehole is tagged, or of the position of the detonator (or the borehole) according to information held in a related database.
(5) Charge weight—i.e. the quantity (mass) of explosive loaded into the borehole.
(6) Lithology—type of rock, strata and geophysical information at the borehole.
(7) The type of explosive in the borehole.
(8) The depth of the borehole.
(9) The number of detonators in the borehole; and the number of boreholes at a given location i.e. at a defined shotpoint in the seismic system
(10) An identity number for the blast site.
(11) Detonator information including an identifier for each detonator in the borehole.
(12) Details of current leakage during tagging.
(13) Tagging date and time.
(14) Temperature of each detonator when tagged.
(15) Pressure inside the borehole exerted by explosive/water on the detonator.
(16) Wire length—i.e. the depth of the detonator, in the borehole, taken from surface.
(17) Type of wire connected to the detonator.
(18) Presence of possible gas pockets, or other potential dangers, in the ground
(19) Other information as may be specified.

The data may be collected or generated on surface using any suitable device or medium, typically when the detonator is tagged, and may be loaded into a memory in, or associated with, the detonator in one step or in multiple steps, as may be appropriate, when required.

The invention further extends to a detonator which includes a housing and attached to or located in the housing at least one sensor for detecting an environmental condition at a location at which the detonator is located and at least one memory for receiving data from the sensor related to the environmental condition.

The sensor may detect pressure which is exerted on the sensor or the housing of the detonator, the presence of water or any other liquid, the presence of a gas at a location at which the detonator is positioned and the like. The invention is not limited in this respect. The detonator may include a plurality of sensors, each sensor being intended to detect the presence or absence of a predetermined and distinct environmental condition.

### BRIEF DESCRIPTION OF THE DRAWINGS

The invention is further described by way of example with reference to the accompanying drawings in which:

FIG. 1 schematically indicates aspects of a blasting system according to the invention, and

FIG. 2 shows details of a central controller and of a mobile device.

### DESCRIPTION OF PREFERRED EMBODIMENT

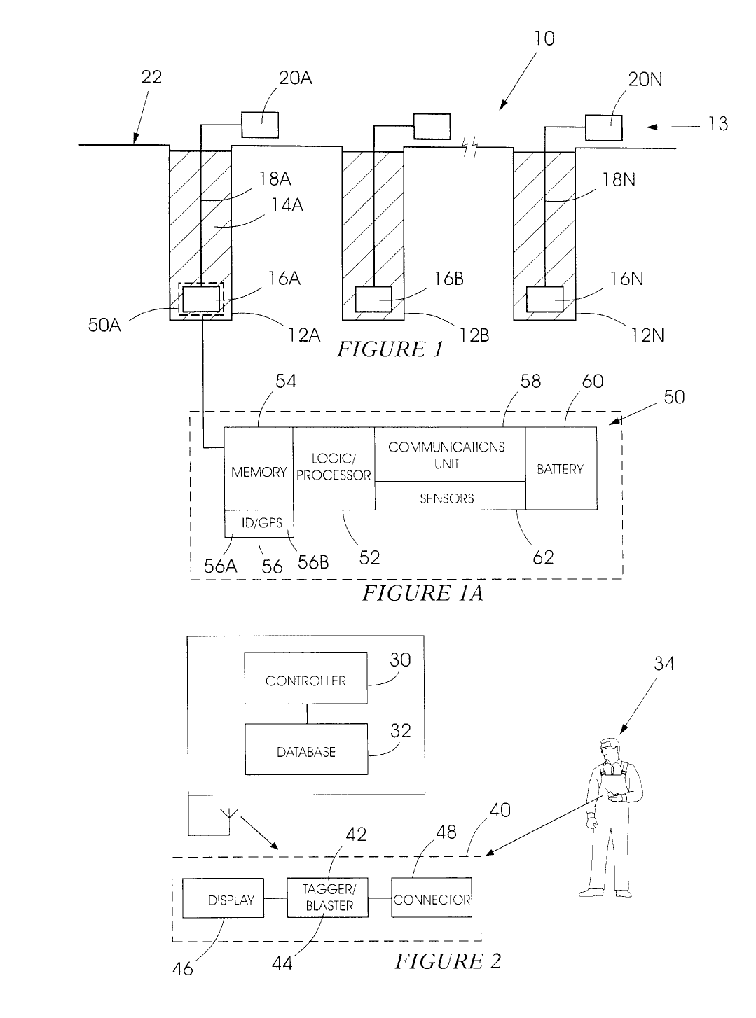

FIG. 1 of the accompanying drawings schematically illustrates a blasting system 10 which includes a number of boreholes 12A, 12B . . . 12N at a blast site 13. Each borehole is drilled to a predetermined depth and is loaded with respective explosive material 14A, 14B . . . 14N and a respective detonator 16A, 16B . . . 16N. Each detonator 16 is connected via a respective wire or conductor 18A . . . 18N to a respective connector 20A . . . 20N located on a surface 22. If required a selected borehole or boreholes could contain two or more detonators at respective spaced locations in the borehole.

The connectors 20 can be coupled directly via a surface harness or bus (not shown) or via a wireless link, to a central controller so that the operation of the blasting system can be controlled.

In order to control aspects of the operation of the blasting system 10 use is made of a central controller 30 which is coupled to a database 32—see FIG. 2. An operator 34 can traverse the blast site 13, in communication with the central controller 30. The operator 34 carries at least one mobile device 40 which may comprise a tagger 42, a handheld blaster 44 and a display 46. For the sake of convenience the components 42 and 44, which are items of equipment generally known in the art, are included in the definition of “mobile device 40”. The device 40 has output terminals in the form of a connector 48 which can be coupled to any of the connectors 20A to 20N on the surface 22. The tagger 42 is used in a known manner to collect predetermined information from each of the detonators 16, and to transfer specified information to each of the detonators 16. The tagger 42 could also be used to implement or conduct validation tests on connections to and on the workings of, the various detonators 16.

In a seismic exploration system, for example, the boreholes 12 are drilled in a predetermined pattern over the surface 22 which is to be seismically mapped. Positional data, determined for example from a GPS system (not shown) relating to each borehole 12 is stored in the database 32. Subsequently each borehole 12 is loaded with the respective explosive 14 and the respective detonator 16. At this time, or shortly thereafter, data on each borehole installation is collected via the tagger 42.

FIG. 1A illustrates an electronic module 50 of a detonator 16. Other components of the detonator 16 are not illustrated. The module 50 includes a logic/processor unit 52, of a kind known in the art, a general memory unit 54, a memory unit 56 specifically used for detonator identity information (56A) and for positional information (56B) of the detonator 16, a communication unit 58, a battery 60, to power electronic components of the detonator, and one or more sensors 62.

The number and type of sensors 62 vary according to requirement. The detonator 16 may for example include a number of sensors 62 each of which is designed to detect and measure the presence of a specified environmental condition at the location at which the detonator is positioned. For example, a first sensor may be used to detect the presence of water, a second sensor may be used to detect and measure the degree of pressure which is exerted on a housing of the detonator, a third sensor may monitor the temperature prevailing at the detonator location and a fourth sensor may be designed to detect the presence of an explosive or noxious gas to which the detonator may be exposed. These examples are non-limiting. Information produced by each sensor 62 is transferred under the control of the logic/processor unit 52, to the memory 54 at predetermined time intervals.

The electronic module 50 is contained, together with other components of the detonator 16, such as its explosive charge (not shown), in a housing 50A which is shown in dotted outline in FIG. 2.

The data collected by the tagger 42 includes information on any one or more of the following aspects or characteristics determined at the time of installation. The following listing of information is exemplary only and non-limiting and other information can be added as appropriate.

(A) Data to be Written into the Detonator Memory 54 During Tagging with the Tagger 42:
(1) Environmental information e.g. temperature and humidity levels, at the blast site 13.
(2) Cautions—depth of borehole, presence of water in the borehole, or any other information to caution an operator before firing of the detonator in the borehole is to take place.
(3) An identity number assigned to the borehole in which the detonator is located.
(4) GPS coordinates—the actual GPS position of the borehole measured when the detonator 16 in the borehole 12 is tagged, or of the position of the detonator (or of the borehole) according to information held in a related database.
(5) Charge weight—i.e. the quantity (mass) of explosive loaded into the borehole 12.
(6) Lithology—type of rock, strata and geophysical information at the borehole 12.
(7) The type of explosive 14 in the borehole.
(8) The depth of the borehole 12.
(9) The number of detonators 16 in the borehole 12.
(10) The number of boreholes at a defined location i.e. at a defined shotpoint in the seismic system.

### (B) Information on the Detonator

(11) An identity number for the blast site 13.
(12) Detonator information including an identifier 56A for each detonator 16 in the borehole 12.
(13) Details of current leakage during tagging.
(14) Tagging date and time.
(15) Temperature of each detonator 16 when tagged.
(16) Pressure inside the borehole 12 exerted by explosive (14)/water on the detonator. This pressure information is generated by means of one of the sensors 62 which, as indicated, is associated with, or which otherwise forms part of, the detonator 16. Other environmental parameters could be measured by appropriate sensors 62 such as the temperature prevailing at the detonator location and whether the detonator, in the blasthole, is exposed to water or a noxious or explosive gas.
(17) Wire (18) length—i.e. the depth of the detonator, in the borehole, taken from the surface 22.

### (C) Other Information

(18) This may be of any kind and, for example, may relate to the existence of possible gas pockets, or other potential dangers, in the ground.

At the time of tagging, the operator 34 couples the connector 48 on the mobile device 40 to the connector 20 of the respective detonator 16 and, via the communication unit 58, data from the tagger 42 is transferred into the memory 54.

It is possible, additionally, to transfer from the tagger 14 the same information or, a selected sub-set of the information, which is transferred to a particular detonator 16, to the database 32 at the control location.

As indicated, in a seismic exploration system, it is quite likely that firing of each detonator 16 will take place some time, e.g. several weeks, after the particular detonator has been installed. Shortly before firing is to take place, the operator 34, using the mobile device 40, traverses the blast site 13. At a chosen detonator 16, a correlation is made between the detonator identity number 56A and the GPS positional information 56B, stored in the memory 56, and similar information obtained from the database 32 pertaining to the detonator 16.

The operator 34, once the respective connectors 20 and 48 have been coupled together (wirelessly or by means of physical connections), is presented with information pertaining to the detonator 16 on the display 46. This information effectively describes all critical parameters which could have an effect on, or which otherwise could influence, the blasting process. Firstly, the information is interpreted to provide safety data to the operator 34. Secondly, after blasting, the information is correlated with information which is obtained when the detonator 16 is fired i.e. the seismic information generated by the explosion, and an evaluation process is carried out to see whether the particular environmental and installation information had any effect on the nature of the seismic information.

The storage of the environmental and installation information in each detonator 16 and the making of that information or selected parts thereof, available to an operator immediately before firing of the detonator 16, enhances the safety of operation during a seismic exploration process, helps to increase the reliability and accuracy of the resulting seismic information and, via the information feedback process referred to, helps to identify factors which could influence the blasting process.

1-9. (canceled)

10. A method of operating a blasting system which includes a plurality of boreholes, each of which is loaded with explosive, and a plurality of detonators, wherein at least one respective detonator is loaded into a respective borehole, wherein the method includes the steps of assigning to each detonator a detonator identity number and determining for each borehole positional information, in respect of each borehole collecting data in a mobile device selected from information relating to the borehole, the detonator in the borehole, the explosive in the borehole and parameters of environmental aspects prevailing at or in the borehole, storing the information collected in the mobile device in at least one of a memory of the detonator and a database at a central location, subsequently, at each detonator, correlating the detonator identity number and the borehole positional information with information retrieved from said stored information, presenting said retrieved information to a mobile device or to a component of the blasting system and assessing parameters which could have an effect on or which could influence the blasting process, and once the detonator has been fired, obtaining seismic information generated by the explosion and carrying out an evaluation process to see whether the environmental and installation information had an effect on the nature of the obtained seismic information thereby to identify factors which could influence a blasting process.

11. A method according to claim 1 wherein the collected data relates to information selected from the following: (1) environmental information, (2) cautions, (3) the mass of explosive in the borehole, (4) the lithology of rock at the borehole, (5) the type of explosive in the borehole, (6) the depth of the borehole, (7) the number of boreholes at a defined location, (8) the number of detonators in the borehole, (9) current leakage during use of the mobile device, (10) time of usage and temperature of the mobile device, (11) temperature of the detonator, (12) pressure inside the borehole exerted by explosive or water on the detonator, (13) depth of the detonator in the borehole taken from surface, (14) gas pockets or other dangers in the ground.

12. A method according to claim 11 wherein the data is collected or generated on surface when the detonator is tagged, and is loaded into the detonator.

13. A method according to claim 10 wherein the data is collected or generated on surface when the detonator is tagged, and is loaded into the detonator.
